(19) United States
(12) Patent Application Publication
(10) Pub. No.: US 2022/0083015 A1
(43) Pub. Date: Mar. 17, 2022

(54) CONVERGED MACHINE LEARNING AND OPERATIONAL TECHNOLOGY DATA ACQUISITION PLATFORM

(71) Applicant: HEWLETT PACKARD ENTERPRISE DEVELOPMENT LP, Houston, TX (US)

(72) Inventors: KENNETH LEACH, Houston, TX (US); AALAP TRIPATHY, Houston, TX (US); RONALD A. NEYLAND, Houston, TX (US)

(21) Appl. No.: 17/022,033

(22) Filed: Sep. 15, 2020

(51) Int. Cl. G05B 19/042; G06N 20/00; G06F 9/54

(52) U.S. Cl. CPC G05B 19/042; G05B 2219/25335; G06F 9/541; G06N 20/00

(57) ABSTRACT

Systems and methods are provided for integrating data acquisition and machine learning (ML) analytics capabilities in a transformative way. The system may implement a discovery phase, a machine learning phase, and an integration phase using hardware and software components. By incorporating these system components, the significant amounts of data may be acquired and analyzed in near real-time to enhance sensor communications with these OT networks and adjust operation of distributed IoT or edge devices.

### DESCRIPTION OF RELATED ART

Operational technology (OT) comprises hardware and software configured to monitor and/or control industrial equipment, assets, processes, and events, Examples of OT devices and systems include programmable logic controllers (PLCs), supervisory control and data acquisition (SCADA) systems, distributed control systems (DCSs), computerized numerical control (CNC) machinery, lighting controls, energy management systems, autonomous and/or non-autonomous transportation systems within the industrial environments, among others. OT systems collect a plurality of OT data regarding the control and operation of such example devices and systems through a plurality of sensors and interfaces. Operational technology (OT) networks provide the critical infrastructure for many industrial control systems. Monitoring the devices and systems within OT networks enables for efficient management of the system. Many of the devices and systems, such as computerized numerical control (CNC) machinery, manufacturing and/or monitoring tools, control valves, Internet of Things (loT) sensors, among others, act as edge devices for the OT network.

### BRIEF DESCRIPTION OF THE DRAWINGS

The present disclosure, in accordance with one or more various embodiments, is described in detail with reference to the following figures. The figures are provided for purposes of illustration only and merely depict typical or example embodiments.

FIG. 1 illustrates a converged edge system in accordance with various embodiments of the disclosure.

FIG. 2 illustrates a distributed system, in accordance with some embodiments described in the present disclosure.

FIG. 3 illustrates integration for streaming data and machine learning (ML) for data acquisition circuit, in accordance with some embodiments described in the present disclosure.

FIG. 4 illustrates an example of a data flow with direct data integration, in accordance with some embodiments described in the present disclosure.

FIG. 5 illustrates an example of a command flow with direct data integration, in accordance with some embodiments described in the present disclosure.

FIG. 6 illustrates a computing component for converging machine learning and operational technology (OT), in accordance with some embodiments described in the present disclosure.

FIG. 7 is an example computing component that may be used to implement various features of embodiments described in the present disclosure.

The figures are not exhaustive and do not limit the present disclosure to the precise form disclosed.

### DETAILED DESCRIPTION

Large amounts of operational technology (OT) data are generated at the edge of OT networks and tapping into this data and acting on it in real-time has the potential to redefine the way in which enterprise organizations and municipalities run their operations. OT Data can consist of physical phenomena captured from the environment such as vibration, temperature, moisture, sound, video, etc. captured directly through IoT sensors or industrial equipment such as Programmable Logic Controllers (PLCs), cameras, or standards enabled I/O.

Once acquired, this data may be incorporated with OT system events, processes, and devices. When data thresholds are incorporated with the data, the system can make adjustments in enterprise and industrial operations based on the data exceeding the data threshold. This may include, for example, adjusting processing or operations in manufacturing and industrial environments, including industrial control systems (ICS), such as supervisory control and data acquisition (SCADA). In other examples, the data from sensors or internet of things (IOT) can manage these industrial environments to adjust water treatment, electrical power, or other automation services.

However, as these systems become more widespread, so does the sources of data and the amount of data they produce. Often the sources of data can create multiple data packets per second. Traditional OT systems are ill-equipped to receive, analyze, and process the large amounts of data in a coherent fashion, which leaves much of the data unused and wasted.

The data may also be used with a machine learning (ML) system to improve operations of the OT system. For example, the data may be processed by a machine learning (ML) system. However, employing ML in such environments can be difficult due to the difficulty of implementation, including adjusting weights and biases in the ML model or merely determining which model would output the best results for management of the OT system.

For example, individual components of the system generate the data, which may include sensors or other individual devices like IOT devices. In these instances, data commonly can originate from multiple, typically unbundled, sources that communicate inefficiently through proxy services, or produce high volume, velocity of data due to high sampling rates corresponding to the state of the art in sensor technology. As such, complete end-to-end IoT solutions are hard to deploy and manage overall, because they can consist of individual components coming from multiple sources, are not typically bundled together, and often communicate inefficiently or indirectly with each other through proxy services via different communication networks.

In some embodiments of the application, the system can include both data acquisition and analytics capabilities in a converged and/or transformative way to converge the ML layer directly into the same system that performs the OT data acquisition. The system may implement a discovery phase, a machine learning phase, and an actuation or control phase using hardware and software components. By incorporating these system components tightly, significant amounts of data may be acquired requiring high performance low latency integration between the aforementioned phases. This can enable analysis in near real-time of data from connected OT equipment, enabling descriptive, diagnostic, predictive and prescriptive analytics algorithms to run on a converged edge system and adjust operation of distributed IoT or edge devices. A normal and abnormal baseline may be set as part of the machine learning algorithms. Failure detection may only be detected by the machine learning algorithm due to a subtle change in one or more channels amongst various acquired by the data acquisition subsystem. Reduction of latency between the discovery, data acquisition and machine learning phases is critical for failure detection/correction to happen in real-time. In the discovery phase, statistical techniques analyze data to determine features that may be indicative of future failure predictions. Accordingly, ML applications can be converged into the same platform that performs OT data acquisition. In this way, one Internet of Things (loT) platform is created that can both acquire data and return control signals back to sensors or OT devices, as well as run ML software that can monitor, manage, and operate on the acquired data in real-time. Enabling ML applications in the combined platform can be accomplished through third party ML containers that are deployed at each edge location where the OT data are generated.

The integration phase may translate one or more communication protocols to enable communication from the data source, to the machine learning system, to an output recognized by the sensor component. The integration phase may incorporate a RESTful API, a messaging protocol implemented through a messaging protocol container, or direct data integration between the source OT data and the ML platform.

In some examples, RESTful API “PUT” calls are made directly from an interface flow editor implemented on the platform that connects OT data within a data service of the platform with internally integrated or external data ingestion destinations. RESTful API “GET” calls from the ML platforms can also be integrated into the converged edge system through the interface flows and can be used to receive or process control signals that are derived from ML platform analytics and sent back to OT sensors or devices.

In some examples, messaging protocols (e.g., MQ Telemetry Transport (MQTT), Advanced Message Queuing Protocol (AMQP), etc.) can be integrated with the data service by installing a messaging protocol container. The messaging protocol container may be installed at the edge to allow for interaction with the OT data acquisition layer via a high speed integrator service (e.g., Kafka, gRPC, Socket.io, NATS.IO, etc.). The messaging protocol container can act as a direct broker service between a data service and ML applications, where the data service collects OT data from sensors and OT devices, and the high speed integrator service can pull new data from the data service which it can then publish to various topics on the messaging bus.

In some examples, native messaging protocols of the OT system can be used to directly integrate OT data from the data service with an ML platform by sending data directly from the data service to the ML platform using the ML platform's or an ML platform provider's own native protocol. The native messaging protocols may be translated from a first native messaging protocol to an industry standard protocol and, in some examples, back to the first native messaging protocol or even a second native messaging protocol (e.g., associated with operating a sensor, etc.).

The combination of the various circuits and their corresponding capabilities, including data acquisition, machine learning controller, and a sensor communication circuit, can reduce latency between generating data at the edge or IoT devices and determining feedback for the sensors based on the generated data. The latency may be reduced by increasing the proximity of traditionally distributed devices. The system may incorporate these circuits at a single system or by incorporating an integrator with the system to reduce communication transmission times. Additionally, the incorporation of these circuits can reduce the translation steps required by distributed systems or integrators that are implemented remotely from a computing system. The system may implement direct connection capabilities to further reduce latency between data acquisition and protocol transmissions for machine learning or other analytics of the data.

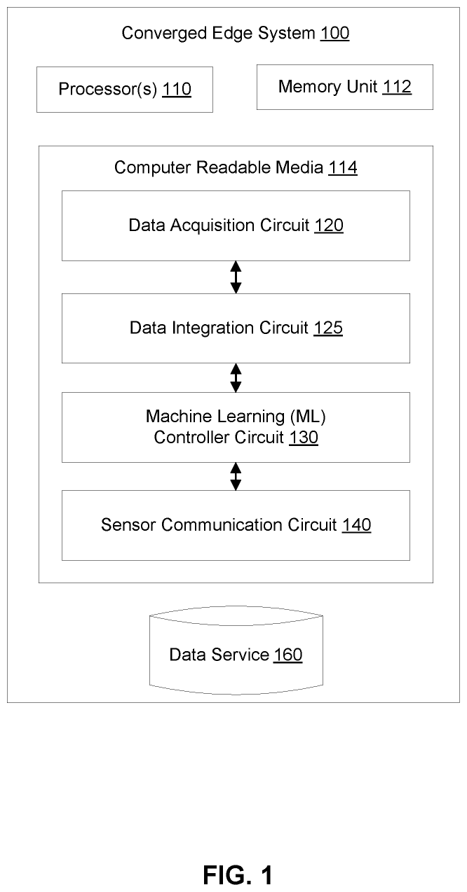

FIG. 1 illustrates a converged edge system in accordance with various embodiments of the disclosure. Converged edge system 100 may comprise processor 110, memory unit 112, and computer readable media 114. Computer readable media 114 may correspond with various circuits, including data acquisition circuit 120, data integration circuit 125, machine learning controller circuit 130, and sensor communication circuit 140. Data from the edge device(s) and processed data to send to sensors associated with the edge device(s) may be stored with data service 160. In some examples, converged edge system 100 may incorporate a graphics processing unit (GPU) and/or tensor processing unit (TPU) to help improve processing at the application-specific integrated circuit (ASIC).

Processor 110 may be one or more central processing units (CPUs), semiconductor-based microprocessors, and/or other hardware devices suitable for retrieval and execution of instructions stored in computer readable media 114. Processor 110 may fetch, decode, and execute instructions to control processes or operations for optimizing the system during run-time. As an alternative or in addition to retrieving and executing instructions, processor 110 may include one or more electronic circuits that include electronic components for performing the functionality of one or more instructions, such as a field programmable gate array (FPGA), application specific integrated circuit (ASIC), or other electronic circuits.

Memory unit 112 may comprise a random access memory (RAM), cache and/or other dynamic storage devices, coupled to a bus for storing information and instructions to be executed by processor 110. Memory unit 112 also may be used for storing temporary variables or other intermediate information during execution of instructions to be executed by processor 110. Such instructions, when stored in storage media accessible to processor 110, render converged edge system 100 into a special-purpose machine that is customized to perform the operations specified in the instructions.

Memory unit 112 may also comprise a read only memory (ROM) or other static storage device coupled to the bus for storing static information and instructions for processor 110. Memory unit 112 may embody a magnetic disk, optical disk, or USB thumb drive (Flash drive) and the like that is provided and coupled to the bus for storing information and instructions.

Computer readable media 114 may be any electronic, magnetic, optical, or other physical storage device that contains or stores executable instructions. In some examples, computer readable media 114 may be Random Access Memory (RAM), non-volatile RAM (NVRAM), an Electrically Erasable Programmable Read-Only Memory (EEPROM), a storage device, an optical disc, and the like. In some embodiments, machine-readable storage medium 504 may be a non-transitory storage medium, where the term “non-transitory” does not encompass transitory propagating signals. As described in detail below, computer readable media 114 may be encoded with executable instructions.

Data acquisition circuit 120 is configured to receive data. For example, the data may be received from various devices, including edge devices of IT networks, outside of a datacenter, in industrial and hostile zones, by non-IT-managed devices, and the like. Data may be stored in a raw format or processed format (e.g., translated from a first communication protocol to a second communication protocol, etc.) at data service 160.

The data may be generated remotely at an edge device. Data may include, for example, status reports and environmental measurements such as vibration, temperature, humidity, acoustics, flow rate, altitude, GPS location, etc., associated with the edge device. Data may be measured by a sensor associated with the edge device and stored with a local memory.

Edge device sensors may measure various data. For example, sensors may be built into industrial machinery or retrofitted to legacy equipment. Stand-alone sensors may also be attached at various points along a production line or deployed at remote sites to monitor unattended processes. At a factory, sensors may be hard-wired to industrial control systems. Wireless sensors powered by batteries or low-voltage connections may collect data that may have been difficult to obtain in the past. For the vibration and temperature and humidity-type sensors, sensors may be used to statistically determine the state of the edge device and predict when it will fail or need maintenance.

In some examples, the sensor data may be tested for accuracy and whether the information source is secure. For accuracy, the sensor data may be compared with a threshold. For security, the edge device may process the sensor data and keep the data in a trusted state.

Data may comprise text, images, video, audio, or other data received by sensors at the edge device. Data may be compressed or encoded locally at the edge device prior to transmission of the data to data acquisition circuit 120, which can decompress and decode the data for processing.

The data may be transmitted. In some examples, the edge device may not have traditionally transmitted the data to another system for acquisition or processing. The edge device may incorporate one or more data ports or other networking components for transferring the data from the edge device, via a network cable, to data acquisition circuit 120 via a communication network. The transmission of data to data acquisition circuit 120 may be initiated when data acquisition circuit 120 transmits a query to the edge device for the data using the local device's native communication protocol to acquire the data. In some examples, the data may be transmitted automatically in response to a trigger incorporated with the edge device and without responding to a query.

The processed data may be delivered to data acquisition circuit 120 without having to transverse a wide-area network back to a cloud service. This may comprise a low-latency and direct integration method (e.g., using data integration circuit 125) between the data and ML analytics planes on one or more converged edge systems.

In some examples, the transmission between edge device and data acquisition circuit 120 may traverse various middleware devices, including a middleware convergence device or a message broker. The middleware device may comprise elements in telecommunication or computer networks where software applications communicate by exchanging formally-defined messages (e.g., using the communication protocol native to the edge device or converged edge system 100, etc.). The middleware device may incorporate message validation, transformation, and routing. It mediates communication amongst applications, minimizing the mutual awareness that applications should have of each other in order to be able to exchange messages, and may implement decoupling. Any of these middleware devices may be incorporated with data acquisition circuit 120 or run as a standalone device.

Data acquisition circuit 120 may translate the data. In some examples, data acquisition circuit 120 may translate the data at a first time between a local communication protocol at the IoT or other edge device and a second communication protocol implemented with data acquisition circuit 120. This may help avoid multiple translation steps that may traditionally be required if the data were to be translated to a middleware device in between communication protocols implemented by the source and data acquisition circuit 120 destination.

In some examples, the middleware device may translate the message from the formal messaging protocol of the edge device to the formal messaging protocol of converged edge system 100. The middleware device may develop a translation process that can translate the communication protocol used by the edge device to a communication protocol understood by machine learning controller circuit 130 or other circuit incorporated with converged edge system 100.

Data integration circuit 125 may incorporate a RESTful API, a messaging protocols implemented through a messaging protocol container, or direct data integration between the source OT data and the ML platform as an integrator component. Data integration circuit 125 can provide an adaptable connection between the downstream data source (e.g., edge or IoT device, etc.) and the upstream machine learning system (e.g., machine learning controller circuit 130). Data integration circuit 125 can enable communications with the data sources regardless of the API that a third party might require to transmit or receive the data, especially where traditional systems may not provide a customized API to translate the data.

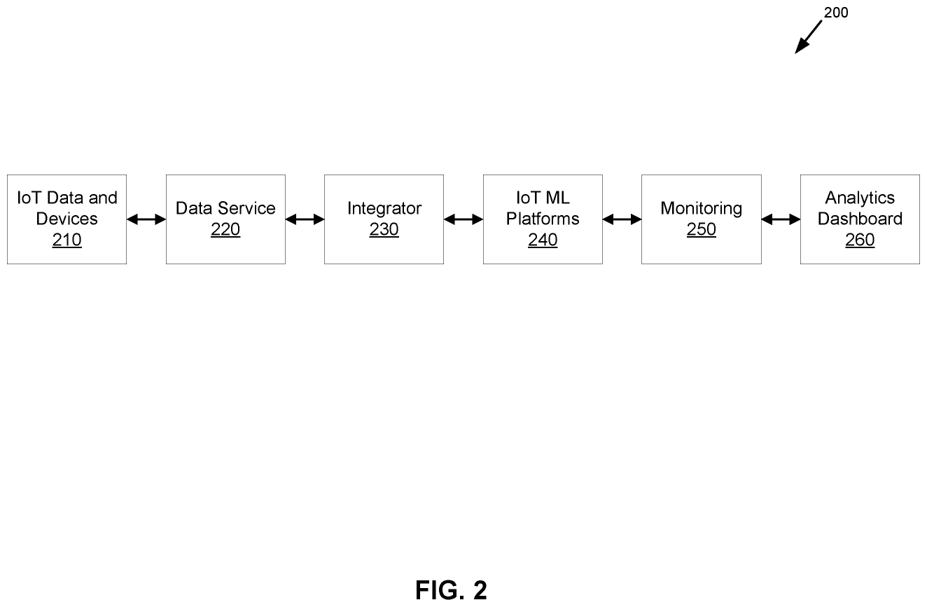

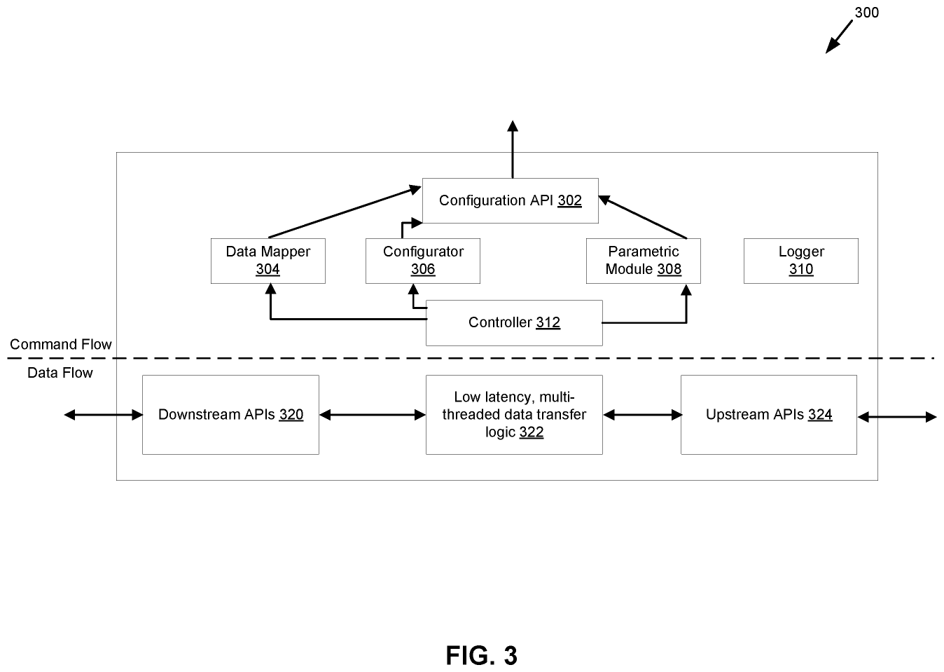

An illustrative data integration circuit 125 is provided in FIG. 2 as integrator 230, which is described in further detail herein with respect to the converged edge system. An illustrative example of integration for streaming data and machine learning (ML) for data integration circuit 125 is provided with FIG. 3.

In FIG. 3, direct data integration component 300 may include various subcomponents. In some examples, direct data integration component 300 may provide a lowest latency and highest computing performance for real-time data capture and actuation between downstream and upstream platforms. Different types of downstream data acquisition APIs and upstream ML Platform APIs may be supported.

The subcomponents may comprise, for example, data mapper 304, which may be configured to receive, as input, a mapping of channels between data integration circuit 125 and block 240 illustrated in FIG. 2. In some examples, data mapper 304 may read a description (e.g., in JSON/YAML) of the mapping of data-streams (i.e. which channel from data acquisition maps to ML platform).

The subcomponents may also comprise configurator module 306 and configuration API 302 which may be configured to handle authentication (e.g., through certificates/API keys, etc.) to downstream and upstream systems respectively. Configuration API 302 may enable configuration of data mapper 304, configurator 306, and parametric module 308 as well as initiating or stopping controller 312.

The subcomponents may comprise parametric module 308 which may be configured to define the data transfer rate between data integration circuit 125 and block 240 illustrated in FIG. 2 (e.g., collection rate from data acquisition circuit 120, injection rate into block 240). In some examples, this process may be one-to-one. In other examples, the capabilities of the transmitting and receiving systems may be different (e.g., due to design constraints). Therefore, instead of carrying the overhead of transmitting them from data integration circuit 125 to block 240 and dropping inputs at block 240 illustrated in FIG. 2, that operation can be performed earlier. This may lead to higher efficiencies. In some examples, parametric module 308 may also be configured to handle prioritization of one or more data-streams (e.g., QoS settings like sampling rate, data exchange rate, etc.).

The subcomponents may also comprise controller 312 that manages the data transfer logic, error handling and error reporting, and low-latency, multi-threaded data transfer logic. Controller 312 may be configured to manage the data transfer logic, error-handling, error reporting via configuration API 302, as well as setting up and unbinding connections to downstream or upstream platforms. The data flow may proceed from downstream APIs 320, to low-latency, multi-threaded data transfer logic 322, and then to upstream APIs 324.

Returning to FIG. 1, interface flows may be implemented. In some examples, RESTful API “PUT” calls are made directly from an interface flow editor implemented with data integration circuit 125 that connects OT data with external data ingestion sources. RESTful API “GET” calls from data integration circuit 125 can also be integrated through the interface flows and can be used to receive or process control signals that are sent back to the edge devices.

In some examples, data integration circuit 125 may incorporate messaging protocols (e.g., MQ Telemetry Transport (MQTT), Advanced Message Queuing Protocol (AMQP), etc.) by installing a messaging protocol container. The messaging protocol container may be installed at the edge to allow for interaction with the OT data acquisition layer via a high speed integrator service (e.g., NATS.IO). The messaging protocol container can act as a direct broker service between data service 160 and ML controller circuit 130, where data service 160 collects OT data from sensors and OT devices (via data acquisition circuit 120), and the high speed integrator service can pull new data from data service 160 which it can then publish to various topics on the messaging bus. Data integration circuit 125 may collect, store, and make available the data.

In some examples, native messaging protocols of the OT system can be used to directly integrate OT data from data service 160 with ML controller circuit 130 by sending data directly from data service 160 to ML controller circuit 130 using a native protocol. The native messaging protocols may be translated from a first native messaging protocol to an industry standard protocol and, in some examples, back to the first native messaging protocol or even a second native messaging protocol (e.g., associated with operating a sensor, etc.).

In some examples, various APIs may be implemented to translate the data. For example, a first API may receive the data from the edge device and a second API may provide the processed data back to a sensor. Any combination of downstream and upstream APIs may be implemented that correspond with the platforms.

ML controller circuit 130 is also configured to analyze the data. Machine learning algorithms can include Deep Neural Networks, Recurrent Neural Networks or other classical algorithms and may include its own historian/database to keep a window of acquired data in a memory or storage buffer. The analysis may create new computer-implemented instructions to help redefine how enterprises and municipalities run business operations. For example, the data may be acquired as real-time OT data to act on and adapt business operations in real-time.

Machine learning controller circuit 130 is configured to employ a machine learning (ML) platform to quickly gain insights into the acquired data in new and useful ways not previously available to human operators. For example, machine learning controller circuit 130 is configured to converge ML layer(s) directly into the same platform that performs OT data acquisition (e.g., data acquisition circuit 120) to create a single IoT platform that can not only acquire data and send control signals back to sensors and OT devices (e.g., via sensor communication circuit 140), but also run the ML software layer that monitors, manages, and operates on the data in a real-time fashion.

The ML application may be enabled through the use of third-party ML containers deployed at each edge location where the OT data is generated. The ML containers may comprise various systems, including third party ML containers (e.g., PTC Thingworx, Foghorn Complex Event Processing, etc.). The runtimes can be installed either on standalone edge compute servers for high-performance ML, or converged onto the same edge server along with the data acquisition and OT control layers for low latency ML.

In some examples, the ML application may support multiple data transmission options, such as RESTful, industry standard AMQP/MOTT, or native built-in protocols used primarily within converged edge system 100. The ML layers may integrate with simple-to-use interfaces (e.g., Node-RED, etc.). The ML applications may be deployed in several implementations, including as a containerized software stack, run on a bare-metal server, or within a virtual machine. The ML applications may be configured to autonomously send control or actuation signals back to the sensor and/or IOT devices.

Machine learning controller circuit 130 is configured to link the ML layer(s) with the OT data acquisition and control layers using industry standard APIs such as RESTful interfaces. For example, RESTful API “PUT” calls can be made directly from an interface which connects OT data within converged edge system 100 (e.g., stored with data service 160) with external data sources or data aggregation sources. In some examples, the interface connecting data sources can automatically generate visual identifiers or diagrams of data flows within the system. This may include a customized RESTful API call that receives the OT data within converged edge system 100 to external sources.

Sensor communication circuit 140 is configured to transmit commands to devices in response to output from the ML model. For example, RESTful API “GET” calls from ML platforms may also be integrated directly from data flows generated and displayed with the interface and are used to receive and process control signals back down to the OT sensors and devices in an efficient manner. This ability to send OT data to and receive control signals back from a highly performance and/or low latent ML layer may be enabled by traversing the integrator service.

FIG. 2 illustrates a distributed system, in accordance with some embodiments described in the present disclosure. Illustration 200 describes a distributed system that directly integrates third party and industry standard messaging protocols (e.g., MQTT, AMQP, etc.) with a converged edge system, including converged edge system 100 illustrated in FIG. 1.

Illustration 200 can allow machine learning software applications to operate with the distributed system. The operation may perform in either low-latent mode directly within containers on the same edge server, separately on secondary edge servers for higher performance and consolidation from multiple OTLink data acquisition devices, or in a centralized location (e.g., in an edge-to-core (E2C) solution).

At block 210, IoT data and edge devices may generate data and be either direct or remotely attached to the data service.

At block 220, a data service may collect the data from the IoT data and edge devices.

At block 230, an integrator component may receive the data from the data service. In some examples, the integrator component may translate data from a first communication protocol to a second communication protocol. The integrator component may implement various processes, for example, Node-RED, REST API, MQTT, or native protocols.

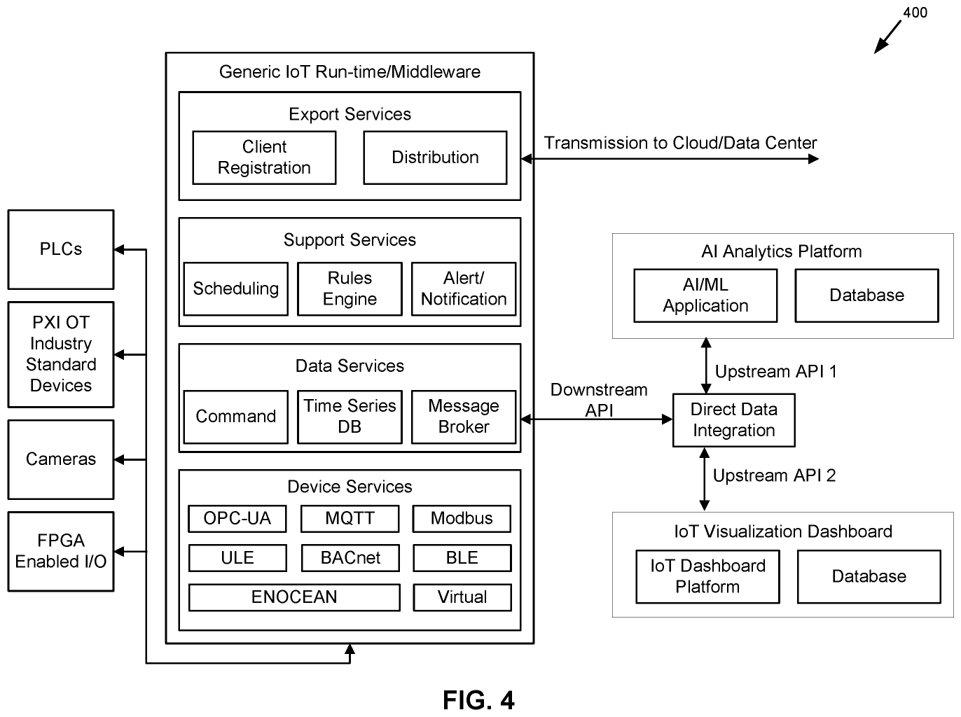

FIG. 4 illustrates an example of a data flow with direct data integration, in accordance with some embodiments described in the present disclosure. Illustration 400 describes how direct data integration may be done between a generic IoT runtime and AI/ML Analytics Platform. Direct data integration component may support accessing the data service (Block 220) via a downstream API; and to a AI/ML Application via an upstream API. The Integrator component may support more than one upstream API. For example, an IoT analytics visual dashboard may be supported to visualize the raw data. This visualization can be augmented with the results of the ML Application as well The direct data integration component shall support downstream export of control signals back to the OT device/IoT actuator at low latencies with predictable and deterministic performance and Quality-of-service.

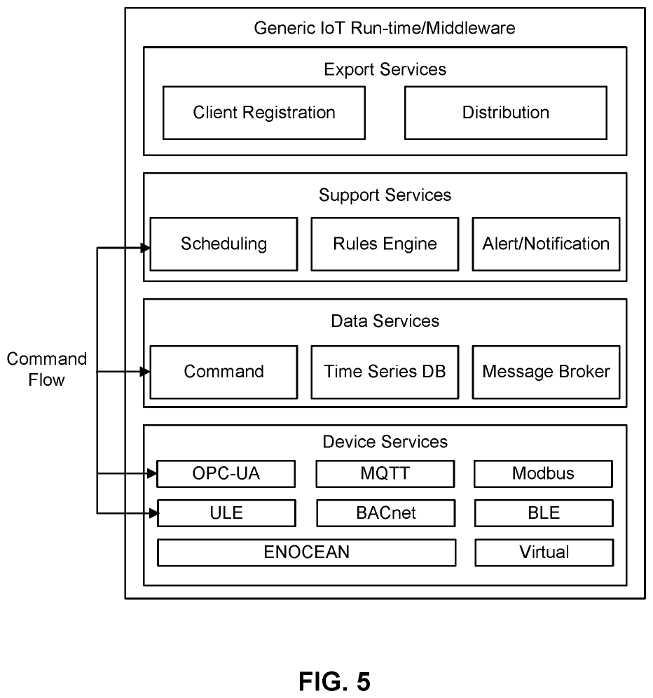

FIG. 5 illustrates an example of a command flow with direct data integration, in accordance with some embodiments described in the present disclosure. The components provided with illustration 400 may be implemented in the command flow of FIG. 5, including commands transmitted between support services, data services, and device services to implement direct data integration.

Returning to FIG. 2 at block 240, an IoT machine learning platform may receive the translated data from the integrator component as input to a machine learning container (e.g., PTC Thingworx, Foghorn Complex Event Processing, etc.). The output of the ML container may determine variable that are transmitted back to the sensor to adjust operation of the sensor at the edge or IoT device. At block 250, the edge or IoT device may be monitored. For example, the system may implement condition monitoring, digital twin generation, IoT visualization, or AR/VR. For example, the output data and analytics from block 240 may be received at block 250 to transform using visualization and reporting tools. These visualization and reporting tools may help manipulate the data into different formats that may be easier to understand by the user or may be easier to process by secondary computing systems.

At block 260, an analytics dashboard may be generated and provided. For example, the transformed data may be presented on the analytics dashboard, provided by an interface at a computing device.

In a sample illustration, a RabbitMQ container with MATT extensions (or other messaging protocol container such as Kafka or NiFi) is installed onto the converged edge system(s) at the edge and interacts with the OT data acquisition layer via a high speed NATS.IO Integrator service 230. This RabbitMQ container acts as a direct broker service between the converged edge system data service and ML applications. The converged edge system data service 220 collects OT data from sensors and OT devices 210, and the MATT Integrator service 230 immediately and efficiently pulls new data from data service 220 and publishes to various topics on the messaging bus (in the example of PTC Thingworx, using MATT 3.1). The ML layer 240 (for example PTC Thingworx) also uses MATT extensions directly to subscribe to the various topics on the messaging bus. By integrating all three layers onto the same edge server, i.e. the data acquisition inside converged edge system data service 220, the messaging publish/subscribe Integrator service 230 using NATS.IO and local MATT messaging container, and the ML applications 240 with MATT extensions within a separate local container, the converged edge system that incorporates the machine learning circuit can achieve a high level of integration which is built on common and easy to use IoT standards/protocols not found within other available solutions.

In some examples, a native communication protocol may be integrated with the distributed system. For example, a communication path may directly integrate OT data coming from the converged edge system data service 220 with an ML platform 240 (for example, PTC's AlwaysOn native protocol and the data service message broker) by sending data directly from the converged edge system data service 220 to ML platform 240 (e.g., PTC Thingworx) in a high-speed highly supported fashion using the ML platform provider's native protocol.

It should be noted that the terms “optimize,” “optimal” and the like as used herein can be used to mean making or achieving performance as effective or perfect as possible. However, as one of ordinary skill in the art reading this document will recognize, perfection cannot always be achieved. Accordingly, these terms can also encompass making or achieving performance as good or effective as possible or practical under the given circumstances, or making or achieving performance better than that which can be achieved with other settings or parameters.

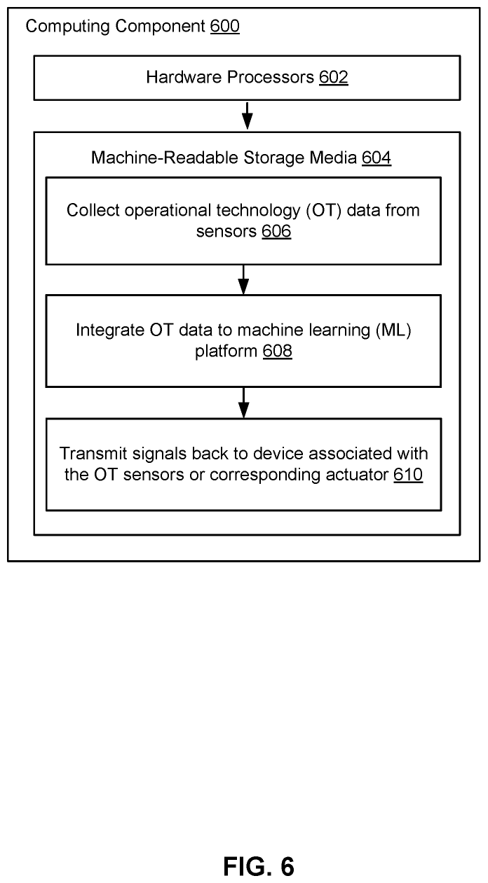

FIG. 6 illustrates an example iterative process performed by a computing component 600 for providing input and receiving inference output from a trained ML model that implements base and adaptive components. Computing component 600 may be, for example, a server computer, a controller, or any other similar computing component capable of processing data. In the example implementation of FIG. 6, the computing component 600 includes a hardware processor 602, and machine-readable storage medium 604. In some embodiments, computing component 600 may be an embodiment of a system corresponding with computer system 100 of FIG. 1.

Hardware processor 602 may be one or more central processing units (CPUs), semiconductor-based microprocessors, and/or other hardware devices suitable for retrieval and execution of instructions stored in machine-readable storage medium 604. Hardware processor 602 may fetch, decode, and execute instructions, such as instructions 606-310, to control processes or operations for optimizing the system during run-time. As an alternative or in addition to retrieving and executing instructions, hardware processor 602 may include one or more electronic circuits that include electronic components for performing the functionality of one or more instructions, such as a field programmable gate array (FPGA), application specific integrated circuit (ASIC), or other electronic circuits.

A machine-readable storage medium, such as machine-readable storage medium 604, may be any electronic, magnetic, optical, or other physical storage device that contains or stores executable instructions. Thus, machine-readable storage medium 604 may be, for example, Random Access Memory (RAM), non-volatile RAM (NVRAM), an Electrically Erasable Programmable Read-Only Memory (EEPROM), a storage device, an optical disc, and the like. In some embodiments, machine-readable storage medium 604 may be a non-transitory storage medium, where the term “non-transitory” does not encompass transitory propagating signals. As described in detail below, machine-readable storage medium 604 may be encoded with executable instructions, for example, instructions 606-610.

Hardware processor 602 may execute instruction 606 to collect data from sensors. The data may comprise operational technology (OT) data from edge devices or IoT devices in a distributed system.

Hardware processor 602 may execute instruction 608 to integrate the OT data to a machine learning (ML) platform. In some examples, the integration of the OT data directly to the one or more ML platforms may include not more than one hop between the plurality of OT sensors and the one or more ML platforms (e.g., 0 hops or 1 hop). In some examples, the one hop comprises a data acquisition layer to a data transmission layer to an ML layer.

Hardware processor 602 may execute instruction 610 to transmit signals back to a device that is associated with at least one of the plurality of OT sensors or corresponding actuator, wherein the device is controlled by the signals. The signals may be generated based on output of the ML platform.

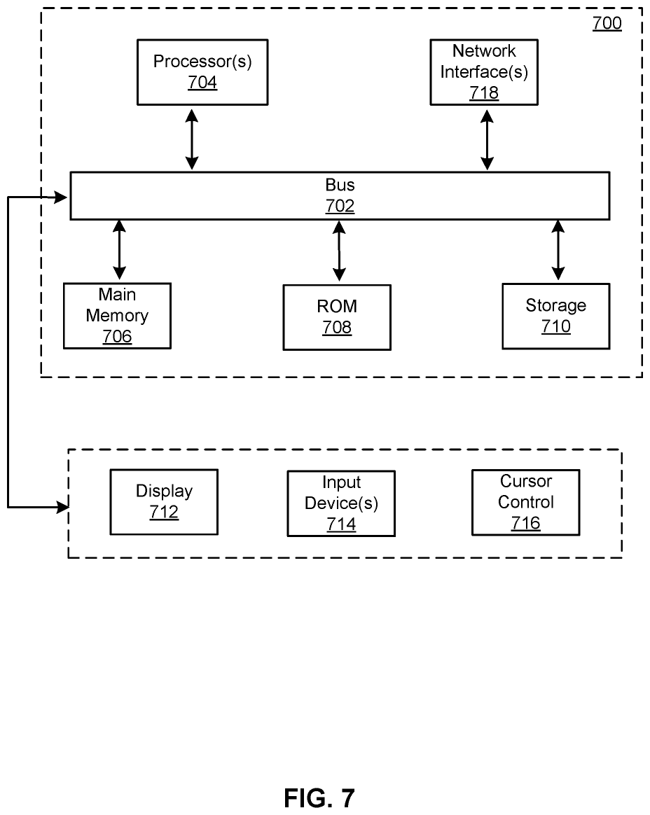

FIG. 7 depicts a block diagram of an example computer system 700 in which various of the embodiments described herein may be implemented. The computer system 700 includes a bus 702 or other communication mechanism for communicating information, one or more hardware processors 704 coupled with bus 702 for processing information. Hardware processor(s) 704 may be, for example, one or more general purpose microprocessors.

The computer system 700 also includes a main memory 706, such as a random access memory (RAM), cache and/or other dynamic storage devices, coupled to bus 702 for storing information and instructions to be executed by processor 704. Main memory 706 also may be used for storing temporary variables or other intermediate information during execution of instructions to be executed by processor 704. Such instructions, when stored in storage media accessible to processor 704, render computer system 700 into a special-purpose machine that is customized to perform the operations specified in the instructions.

The computer system 700 further includes a read only memory (ROM) 708 or other static storage device coupled to bus 702 for storing static information and instructions for processor 704. A storage device 710, such as a magnetic disk, optical disk, or USB thumb drive (Flash drive), etc., is provided and coupled to bus 702 for storing information and instructions.

The computer system 700 may be coupled via bus 702 to a display 712, such as a liquid crystal display (LCD) (or touch screen), for displaying information to a computer user. An input device 714, including alphanumeric and other keys, is coupled to bus 702 for communicating information and command selections to processor 704. Another type of user input device is cursor control 716, such as a mouse, a trackball, or cursor direction keys for communicating direction information and command selections to processor 704 and for controlling cursor movement on display 712. In some embodiments, the same direction information and command selections as cursor control may be implemented via receiving touches on a touch screen without a cursor.

The computing system 700 may include a user interface module to implement a GUI that may be stored in a mass storage device as executable software codes that are executed by the computing device(s). This and other modules may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables.

In general, the word “component,” “engine,” “system,” “database,” data store,” and the like, as used herein, can refer to logic embodied in hardware or firmware, or to a collection of software instructions, possibly having entry and exit points, written in a programming language, such as, for example, Java, C or C++. A software component may be compiled and linked into an executable program, installed in a dynamic link library, or may be written in an interpreted programming language such as, for example, BASIC, Perl, or Python. It will be appreciated that software components may be callable from other components or from themselves, and/or may be invoked in response to detected events or interrupts. Software components configured for execution on computing devices may be provided on a computer readable medium, such as a compact disc, digital video disc, flash drive, magnetic disc, or any other tangible medium, or as a digital download (and may be originally stored in a compressed or installable format that requires installation, decompression or decryption prior to execution). Such software code may be stored, partially or fully, on a memory device of the executing computing device, for execution by the computing device. Software instructions may be embedded in firmware, such as an EPROM. It will be further appreciated that hardware components may be comprised of connected logic units, such as gates and flip-flops, and/or may be comprised of programmable units, such as programmable gate arrays or processors.

The computer system 700 may implement the techniques described herein using customized hard-wired logic, one or more ASICs or FPGAs, firmware and/or program logic which in combination with the computer system causes or programs computer system 700 to be a special-purpose machine. According to one embodiment, the techniques herein are performed by computer system 700 in response to processor(s) 704 executing one or more sequences of one or more instructions contained in main memory 706. Such instructions may be read into main memory 706 from another storage medium, such as storage device 710. Execution of the sequences of instructions contained in main memory 706 causes processor(s) 704 to perform the process steps described herein. In alternative embodiments, hard-wired circuitry may be used in place of or in combination with software instructions.

The term “non-transitory media,” and similar terms, as used herein refers to any media that store data and/or instructions that cause a machine to operate in a specific fashion. Such non-transitory media may comprise non-volatile media and/or volatile media. Non-volatile media includes, for example, optical or magnetic disks, such as storage device 710. Volatile media includes dynamic memory, such as main memory 706. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, and networked versions of the same.

Non-transitory media is distinct from but may be used in conjunction with transmission media. Transmission media participates in transferring information between non-transitory media. For example, transmission media includes coaxial cables, copper wire and fiber optics, including the wires that comprise bus 702. Transmission media can also take the form of acoustic or light waves, such as those generated during radio-wave and infra-red data communications.

The computer system 700 also includes a communication interface 718 coupled to bus 702. Communication interface 718 provides a two-way data communication coupling to one or more network links that are connected to one or more local networks. For example, communication interface 718 may be an integrated services digital network (ISDN) card, cable modem, satellite modem, or a modem to provide a data communication connection to a corresponding type of telephone line. As another example, communication interface 718 may be a local area network (LAN) card to provide a data communication connection to a compatible LAN (or WAN component to communicated with a WAN). Wireless links may also be implemented. In any such implementation, communication interface 718 sends and receives electrical, electromagnetic or optical signals that carry digital data streams representing various types of information.

A network link typically provides data communication through one or more networks to other data devices. For example, a network link may provide a connection through local network to a host computer or to data equipment operated by an Internet Service Provider (ISP). The ISP in turn provides data communication services through the world wide packet data communication network now commonly referred to as the “Internet.” Local network and Internet both use electrical, electromagnetic or optical signals that carry digital data streams. The signals through the various networks and the signals on network link and through communication interface 718, which carry the digital data to and from computer system 700, are example forms of transmission media.

The computer system 700 can send messages and receive data, including program code, through the network(s), network link and communication interface 718. In the Internet example, a server might transmit a requested code for an application program through the Internet, the ISP, the local network and the communication interface 718.

The received code may be executed by processor 704 as it is received, and/or stored in storage device 710, or other non-volatile storage for later execution.

Each of the processes, methods, and algorithms described in the preceding sections may be embodied in, and fully or partially automated by, code components executed by one or more computer systems or computer processors comprising computer hardware. The one or more computer systems or computer processors may also operate to support performance of the relevant operations in a “cloud computing” environment or as a “software as a service” (SaaS). The processes and algorithms may be implemented partially or wholly in application-specific circuitry. The various features and processes described above may be used independently of one another, or may be combined in various ways. Different combinations and sub-combinations are intended to fall within the scope of this disclosure, and certain method or process blocks may be omitted in some implementations. The methods and processes described herein are also not limited to any particular sequence, and the blocks or states relating thereto can be performed in other sequences that are appropriate, or may be performed in parallel, or in some other manner. Blocks or states may be added to or removed from the disclosed example embodiments. The performance of certain of the operations or processes may be distributed among computer systems or computers processors, not only residing within a single machine, but deployed across a number of machines.

As used herein, a circuit might be implemented utilizing any form of hardware, software, or a combination thereof. For example, one or more processors, controllers, ASICs, PLAs, PALs, CPLDs, FPGAs, logical components, software routines or other mechanisms might be implemented to make up a circuit. In implementation, the various circuits described herein might be implemented as discrete circuits or the functions and features described can be shared in part or in total among one or more circuits. Even though various features or elements of functionality may be individually described or claimed as separate circuits, these features and functionality can be shared among one or more common circuits, and such description shall not require or imply that separate circuits are required to implement such features or functionality. Where a circuit is implemented in whole or in part using software, such software can be implemented to operate with a computing or processing system capable of carrying out the functionality described with respect thereto, such as computer system 700.

As used herein, the term “or” may be construed in either an inclusive or exclusive sense. Moreover, the description of resources, operations, or structures in the singular shall not be read to exclude the plural. Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps.

Terms and phrases used in this document, and variations thereof, unless otherwise expressly stated, should be construed as open ended as opposed to limiting. Adjectives such as “conventional,” “traditional,” “normal,” “standard,” “known,” and terms of similar meaning should not be construed as limiting the item described to a given time period or to an item available as of a given time, but instead should be read to encompass conventional, traditional, normal, or standard technologies that may be available or known now or at any time in the future. The presence of broadening words and phrases such as “one or more,” “at least,” “but not limited to” or other like phrases in some instances shall not be read to mean that the narrower case is intended or required in instances where such broadening phrases may be absent.

What is claimed is:

1. A converged edge system comprising:
a processor; and
a memory unit including computer code that when executed, causes the processor to:
collect operational technology (OT) data from a plurality of OT sensors;
integrate the OT data directly to one or more machine learning (ML) platforms of the converged edge system operationalizing one or more ML models using the OT data in real-time; and
transmit signals back to a device that is associated with at least one of the plurality of OT sensors or corresponding actuator, wherein the device is controlled by the signals.

2. The converged edge system of claim 1, wherein the integration of the OT data directly to the one or more ML platforms includes not more than one hop between the plurality of OT sensors and the one or more ML platforms.

3. The converged edge system of claim 2, wherein the one hop comprises a data acquisition layer to a data transmission layer to an ML layer.

4. The converged edge system of claim 1, wherein the integration of the OT data directly to the one or more ML platforms of the converged edge system incorporates RESTful API calls made directly from an interface flow editor implemented on the converged edge system.

5. The converged edge system of claim 1, wherein the integration of the OT data directly to the one or more ML platforms of the converged edge system installs a messaging protocol directly onto the converged system's operating system or virtualized via a container to implement the messaging protocol.

6. The converged edge system of claim 5, wherein the messaging protocol includes MQ Telemetry Transport (MQTT) or Advanced Message Queuing Protocol (AMQP).

7. The converged edge system of claim 1, wherein the integration of the OT data directly to one or more ML platforms running on the converged edge system sends the OT data directly from a messaging broker or native API to one or more ML platforms using a native protocol of one or more ML platforms.

8. A computer-implemented method comprising:
collecting operational technology (OT) data from a plurality of OT sensors;
integrating the OT data directly to one or more machine learning (ML) platforms of a converged edge system operationalizing one or more ML models using the OT data in real-time; and
transmitting signals back to a device that is associated with at least one of the plurality of OT sensors or corresponding actuator, wherein the device is controlled by the signals.

9. The computer-implemented method of claim 8, wherein the integration of the OT data directly to the one or more ML platforms includes not more than one hop between the plurality of OT sensors and the one or more ML platforms.

10. The computer-implemented method of claim 9, wherein the one hop comprises a data acquisition layer to a data transmission layer to an ML layer.

11. The computer-implemented method of claim 8, wherein the integration of the OT data directly to the one or more ML platforms of the converged edge system incorporates RESTful API calls made directly from an interface flow editor implemented on the converged edge system.

12. The computer-implemented method of claim 8, wherein the integration of the OT data directly to the one or more ML platforms of the converged edge system installs a messaging protocol directly onto the converged system's operating system or virtualized via a container to implement the messaging protocol.

13. The computer-implemented method of claim 12, wherein the messaging protocol includes MQTelemetry Transport (MQTT) or Advanced Message Queuing Protocol (AMQP).

14. The computer-implemented method of claim 8, wherein the integration of the OT data directly to the one or more ML platforms of the converged edge system sends the OT data directly from a messaging broker or native API to one or more ML platforms using a native protocol of one or more ML platforms.

15. A non-transitory computer-readable storage medium storing a plurality of instructions executable by one or more processors, the plurality of instructions when executed by the one or more processors cause the one or more processors to:
collect operational technology (OT) data from a plurality of OT sensors;
integrate the OT data directly to one or more machine learning (ML) platforms of the converged edge system operationalizing one or more ML models using the OT data in real-time; and
transmit signals back to a device that is associated with at least one of the plurality of OT sensors or corresponding actuator, wherein the device is controlled by the signals.

16. The computer-readable storage medium of claim 15, wherein the integration of the OT data directly to the one or more ML platforms includes not more than one hop between the plurality of OT sensors and the one or more ML platforms.

17. The computer-readable storage medium of claim 16, wherein the one hop comprises a data acquisition layer to a data transmission layer to an ML layer.

18. The computer-readable storage medium of claim 15, wherein the integration of the OT data directly to the one or more ML platforms of the converged edge system incorporates RESTful API calls made directly from an interface flow editor implemented on the converged edge system.

19. The computer-readable storage medium of claim 15, wherein the integration of the OT data directly to the one or more ML platforms of the converged edge system installs a messaging protocol directly onto the converged system's operating system or virtualized via a container to implement the messaging protocol.

20. The computer-readable storage medium of claim 19, wherein the messaging protocol includes MQTelemetry Transport (MQTT) or Advanced Message Queuing Protocol (AMQP).

21. The computer-readable storage medium of claim 15, wherein the integration of the OT data directly to one or more ML platforms running on the converged edge system sends the OT data directly from a messaging broker or native API to one or more ML platforms using a native protocol of one or more ML platforms.
